(19) United States
(12) Patent Application Publication
(10) Pub. No.: US 2024/0123418 A1
(43) Pub. Date: Apr. 18, 2024

(54) APPARATUS FOR ANALYZING REACTION SYSTEMS

(71) Applicant: HTE GMBH THE HIGH THROUGHPUT EXPERIMENTATION COMPANY, Heidelberg (DE)

(72) Inventors: Andreas Mueller, Heidelberg (DE); Peter Kolb, Heidelberg (DE); Michael Dejmek, Heidelberg (DE); Max Christoph Schmid, Heidelberg (DE)

(21) Appl. No.: 18/279,702

(22) PCT Filed: Mar. 4, 2022
(86) PCT No.: PCT/EP2022/055596

§ 371 Date: Aug. 31, 2023

(30) Foreign Application Priority Data
Mar. 4, 2021 (EP) 21160701.5

(51) Int. Cl. B01J 19/00; G05D 16/00

(52) U.S. Cl. CPC B01J 19/0006; B01J 19/0046; B01J 19/0093; G05D 16/024; B01J 2219/00306; B01J 2219/00337; B01J 2219/00369; B01J 2219/00585; B01J 2219/00689; B01J 2219/00698; B01J 2219/00704; B01J 2219/00997

(57) ABSTRACT

The invention relates to an apparatus for analyzing reaction systems with a liquid phase (13) and a gas phase (15), the apparatus (1) comprising at least two tank reactors (3), a common feed line (5), a common drain line (25) for the liquid phase and a common drain line (21) for the gas phase, each tank reactor (3) being connected to the common feed line (5) by a supply line (7), to the common drain line (25) for the liquid phase by a liquid withdrawal line (27) and to the common drain line (21) for the gas phase by a gas withdrawal line (23), wherein the pressure in each tank reactor (3) is controlled by one of:
(a) a pressure control (31) in the common feed line (5);
(b) a pressure line (29) which is connected to the gas space of each tank reactor (3);
(c) a pressure control (31) in the common drain line (21) for the gas phase and a flow restrictor (33) in the common drain line (25) for the liquid phase or a pressure control (31) in the common drain line (25) for the liquid phase and a flow restrictor (33) in the common drain line (21) for the gas phase; or
(d) a pressure line (29) which enters into the common drain line (25) for the liquid phase or into the common drain line (21) for the gas phase.

The invention further relates to a process for analyzing reaction systems in such an apparatus.

The invention relates to an apparatus for analyzing reaction systems with a liquid phase and a gas phase, the apparatus comprising at least two tank reactors, a common feed line, a common drain line for the liquid phase and a common drain line for the gas phase, each reactor being connected to the common feed line by a supply line, to the common drain line for the liquid phase by a liquid withdrawal line and to the common drain line for the gas phase by a gas withdrawal line.

Apparatuses for analyzing reaction systems particularly are used, if a large number of reactions shall be carried out either under identical conditions or with slightly differing conditions.

Usually, such reaction systems are operated continuously and the reactors used in the reaction systems are continuous reactors like tube reactors.

Different systems for analyzing reactions or performing experiments using tube reactors are described for example in US-A 2014/0131515, WO-A 2006/107187, WO-A 2005/063372, WO-A 2014/062056 or DE-A 10 2007 047 658. However, due to the use of the tube reactor, it is not possible to carry out batchwise reactions or analyze reactions where reactants or secondary components are added at different reaction times.

For carrying out reactions under identical pressure and temperature conditions, GB-A 2355674 discloses a multi-cell reactor which incorporates a number of vessels. For setting the vessels under pressure, a gas distribution pipe is provided by which a pressurized gas can be fed into the vessels. After finishing the reactions, the vessels are depressurized by opening a gas outlet valve.

A batch reaction system which comprises at least two batch reactors which are connected to a fluid inlet and a gas outlet is disclosed in EP-A 1 317 954. Also WO-A 027053278 discloses an apparatus for performing a multiplicity of physical and/or chemical operations. This apparatus comprises a plurality of reaction vessels, support means for supporting the reaction vessels and a closure member adapted for movement relative to the support means.

However, none of the systems for analyzing reactions allows for analyzing two phase systems in which liquids and gases are added at different times and which usually are carried out in tank reactors which have completely different properties compared to flow-through reactors like tube reactors.

Therefore, it is an object of the present invention to provide an apparatus for analyzing reaction systems with a liquid phase and a gas phase, the apparatus comprising at least two tank reactors, a common feed line, a common drain line for the liquid phase and a common drain line for the gas phase, each reactor being connected to the common feed line by a supply line, to the common drain line for the liquid phase by a liquid withdrawal line and to the common drain line for the gas phase by a gas withdrawal line, wherein the pressure in each reactor is controlled by one of:
(a) a pressure control in the feed line;
(b) a pressure line which is connected to the gas space of each tank reactor;
(c) a pressure control in the common drain line for the gas phase and a flow restrictor in the common drain line for the liquid phase or a pressure control in the common drain line for the liquid phase and a flow restrictor in the common drain line for the gas phase; or
(d) a pressure line which enters into the common drain line for the liquid phase or in the common drain line for the gas phase.

By using tank reactors in the apparatus for analyzing reaction systems, it is possible to set properties like those as usually arise in tank reactors and, therefore, it is possible to more precisely analyze reactions which usually are not carried out in continuously operating reactors. Further, using tank reactors allows for feeding components at different times and different reaction progress.

By connecting the tank reactors with a common feed line, the same feed can be fed into each of the tank reactors which allows for comparing the reactions which are carried out in the tank reactors. Particularly, if the apparatus is used for analyzing two-phase reactions, particularly reactions with a liquid phase and a gas phase, it is necessary to separately remove the liquid phase and the gas phase. Therefore, each reactor is connected with the common drain line for the liquid phase and the common drain line for the gas phase.

Controlling the pressure in the tank reactors further allows for carrying out reactions at elevated pressure or alternatively at reduced pressure, however, particularly at elevated pressure. By using the pressure line which is connected to the gas space of each tank reactor, by using the pressure control in the common drain line for the gas phase or in the common drain line for the liquid phase or by using the pressure line which enters into the common drain line for the liquid phase or in the common drain line for the gas phase, all reactors are operated at the same pressure. For setting the pressure in each tank reactor, the pressure is controlled by the pressure control in the feed line. Additionally, for setting an individual pressure in each tank reactor it is possible to provide a pressure control in each supply line. The pressure control in the supply line can be combined with any of the other three types of pressure control. In this case, a common pressure can be set by using the pressure line which is connected to the gas space of each tank reactor, by using the pressure control in the common drain line for the gas phase or in the common drain line for the liquid phase or by using the pressure line which enters into the common drain line for the liquid phase or in the common drain line for the gas phase and deviations from that common pressure in each reactor can be set by the pressure control in the supply line. Further, the pressure control in the supply line can be used to exactly set the pressure in each tank reactor.

The tank reactor can be any tank reactor known to the skilled person. The type of tank reactor used in the apparatus particularly depends on the kind of reaction to be analyzed. Suitable types for the tank reactor for example are a stirred tank reactor, a continuous stirred tank reactor, a fed-batch reactor, a batch reactor or a jet loop reactor. In the apparatus for analyzing reactions, all reactors may be of the same type. However, it is also possible to use different types of reactors. Using different types of reactors allows for analyzing the influence of the type of reactor on the reaction. The type of reactor can be changed in an easy way by changing the interior setup of the vessels. Interior setups are for example baskets which modify the contact properties between a heterogeneous catalyst or absorber or any other type of component which undergoes a reaction with the medium inside the vessel. Typical baskets are Berty, Carberry or Robinson-Mahoney type inserts. Another variation could be the type of stirring applied as mechanical driven rotational stirring or aerodynamic stirring using jet propulsion as the energy source. The tank reactors used in the apparatus for analyzing reaction systems preferably have a size in a range from 25 to 100 ml, particularly in a range from 25 to 75 ml. Further, it is preferred that the ratio of reactor height to diameter is in a range from 1:1 to 1:5.

For controlling the pressure, in a first alternative, a pressure control in the feed line is used. In this case, it is necessary that the pressure in the feed line is higher than the pressure in the tank reactors. The pressure control in the feed line may be combined with a flow restrictor in the supply line, for example a capillary tube. By using the flow restrictor, the flow of the component flowing through the flow restrictor can be set and by setting the flow through the flow restrictor also the pressure in the tank reactor can be varied. Besides or additionally, a pressure regulator can be placed in the supply line. If a pressure regulator is used, the pressure regulator can be any pressure regulator known to a skilled person. Suitable pressure regulators for example are diaphragm pressure regulators, piston type pressure regulators, bellows pressure regulators or proportional overpressure regulators.

For controlling the pressure in each tank reactor by a pressure line which is connected to the gas space of each tank reactor, a pressurized fluid, particularly a pressurized gas is fed into the tank reactors. If the pressure line directly is connected to the gas space of each tank reactor, pressurized fluid flows into each reactor until the pressure in each tank reactor is the same as the pressure in the pressure line. To set a pressure in each tank reactor which may deviate from the pressure in the pressure line, a valve can be provided in the connection between the pressure line and the tank reactor. By opening the valve, fluid flows from the pressure line into the tank reactor and after closing the valve no more fluid can enter from the pressure line and the pressure in the tank reactor is set to the value at which the valve is closed. However, this arrangement has the disadvantage that the pressure in the tank reactor may change during carrying out the process in the tank reactor, for example the chemical reaction. Therefore, it is particularly preferred to use either a flow restrictor in the connection from the pressure line to the tank reactor or to carry out the process in the tank reactor while the valve is not closed or set to a predefined valve position. In this case, if the pressure is reduced during the operation in the reactor, fluid can enter into the reactor or if the pressure increases, gas may flow out of the reactor and hereby, the pressure in the tank reactor is kept constant during the process. If all reactors are set to the same pressure, it is also possible to provide a pressure controller in the pressure line for setting the pressure in the pressure line and by setting the pressure in the pressure line also the pressure in all tank reactors is set without providing a flow restrictor, a valve or a pressure controller in each connection between the tank reactor and the pressure line.

In a further alternative of the invention, the pressure control is realized by a pressure control in the common drain line for the gas phase and a flow restrictor in the common drain line for the liquid phase or by a pressure control in the common drain line for the liquid phase and a flow restrictor in the common drain line for the gas phase. In this case, the pressure in each tank reactor is increased by the pressure of the components fed into the tank reactor or by using the pressure line which is connected to the gas space of each tank reactor. Using the pressure control in the common drain line for the gas phase or in the common drain line for liquid phase results in setting the pressure in the common drain line for the gas phase or for the liquid phase. Due to the pressure compensation, by controlling the pressure in the common drain line for the gas phase or for the liquid phase, also the pressure in each tank reactor is set. The pressure controller in this case is placed at a position in the common drain line for the gas phase or for the liquid phase which is downstream of all liquid withdrawal lines entering into the common drain line for the liquid phase or downstream of all gas withdrawal lines entering into the common drain line for the gas phase, respectively. Further, to control the pressure in the tank reactors, the pressure regulator used for controlling the pressure in the common drain line for the liquid phase or in the common drain line for the gas phase is an upstream pressure regulator.

By additionally providing the flow restrictor in the common drain line for the liquid phase if the pressure control is in the common drain line for the gas phase, the pressure in the liquid volume in the reactor is kept at the same pressure level as in the common drain line for the gas phase which is regulated by the pressure control. The flow restrictor in the common drain line for the gas phase if the pressure control is realized in the common drain line for the liquid phase keeps the pressure in the gas volume in the reactor at the same pressure level as in the common drain line for the liquid phase which is regulated by the pressure control.

Besides controlling the pressure in the common drain line for the liquid phase or in the common drain line for the gas phase and to achieve the specified pressure in each tank reactor by the pressure of the components fed into the reactor or by a pressure line which is connected to the gas space of each tank reactor, in a further alternative, the pressure is controlled by a pressure line which enters into the common drain line for the liquid phase or in the common drain line for the gas phase. The position, where the pressure line enters into the common drain line for the liquid phase or in the common drain line for the gas phase may be any point in the respective drain line, however, particularly preferably, the pressure line enters into the respective drain line at a position downstream of all gas withdrawal lines or liquid withdrawal lines into the respective drain line. Further, for setting the pressure in the tank reactors, it is preferred to additionally provide a flow restrictor or an upstream pressure regulator downstream the position at which the pressure line enters into the respective drain line. Using a pressure line which enters into the common drain line for the liquid phase or in the common drain line for the gas phase for controlling the pressure has the advantage that it is possible to set the pressure in the reactors or to keep the pressure in the reactors constant also in cases where only small amounts of the liquid phase or the gas phase is removed from the reactor or where the amount of liquid phase or gas phase withdrawn from the reactor oscillates.

If for controlling the pressure in each tank reactor a pressure line is provided which is connected to the gas space of each tank reactor or which enters into the common drain line for the liquid phase or in the common drain line for the gas phase, it is preferred that the pressure line is connected to a supply for an inert gas. By using the inert gas, the pressure in the tank reactors can be set without using a component which influences the reaction. The inert gas can be any gas which is inert regarding the reaction to be analyzed. Gases which generally are used as inert gases for example are nitrogen, carbon dioxide or noble gases like argon.

The supply for the inert gas can be any supply known to a skilled person. If the inert gas can be air, the supply for example is a general compressed-air pipe which for example is connected to an air blower by which the pressurized air is fed into the compressed-air pipe.

If a gas different from air is used as inert gas, it is particularly preferred that the supply for inert gas is a pressure tank. In this context, depending on the amount of pressurized gas needed for controlling the pressure, the pressure tank may be a gas bottle or a battery of gas bottles. To achieve a constant pressure of the inert gas in the pressure line, it is preferred that a pressure regulator is arranged between the pressure tank and the pressure line. Further, particularly if a pressure regulator is used, it is preferred that the pressure of the gas in the pressure tank is higher than the pressure of the gas in the pressure line. By this arrangement, it is possible to ensure a constant pressure in the pressure line. Further, by using a controllable pressure regulator, it is possible to set a constant pressure in the pressure line even if the pressure in the pressure tank reduces due to the withdrawal of gas.

Particularly, if the pressure control is provided in the common drain line for the liquid phase, it is particularly preferred that the liquid withdrawal line enters the tank reactor by a dip pipe. By using the dip pipe, liquid is pressed into the liquid withdrawal line if the pressure in the tank reactor rises. This allows for a simple pressure control in the tank reactor without using a valve in the withdrawal line which must be opened to withdraw liquid if the pressure is too high or must be closed if the pressure in the tank reactor corresponds to the required pressure.

In general the length of the dip tube allows to select which type of fluid should be used for pressure control. A dip tube that enters into the liquid region, preferably to the bottom of the tank reactor, is used for control in the liquid withdrawal line. A dip tube that enters into the gas phase region is used to control the pressure in the gas withdrawal line. A dip tube that exactly touches the boundary region between gas and liquid is used for controlling the pressure in a then combined gas and liquid drain line. Additionally, sampling of liquids from inside of the vessel is possible only with a dip tube which enters into the liquid itself unless sampling via a bottom drain valve is foreseen. A bottom drain valve has the disadvantage that additional automation is required for controlling the opening and closing without introducing a pressure loss during activation of the valve.

Reaction systems with a liquid phase and a gas phase which can be analyzed by using the inventive apparatus are reaction systems where the reactants are liquid and at least one reaction product is gaseous, reaction systems where the reactants are gaseous and at least one reaction product is liquid or reaction systems where at least one reactant is liquid and at least one reactant is gaseous. If at least one reactant is liquid and at least one reactant is gaseous, the reaction product may be either gaseous or liquid or, particularly if more than one reaction product is obtained, at least one reaction product is liquid and at least one reaction product is gaseous. Further, reaction systems with a liquid phase and a gas phase also comprise reactions which are carried out in the liquid phase which means that all reactants and all reaction products are liquid and additionally, the tank reactor contains an inert gas phase.

The reactants of the reaction system may comprise main components and optionally secondary components.

The main components may be fed into the tank reactor either all at once or continuously during the reaction time. For dosing the main components, a flow controller may be provided in the common feed line. Further by using flow restrictors in the supply lines, the feed of the main components into each tank reactor can be controlled.

To further achieve a constant flow which exactly sets the flow rate, it is preferred to arrange a flow restrictor between the valves in the supply line. Particularly preferably, the flow restrictor is a capillary tube and in this case, the supply line between the valves may be designed as capillary tube.

The feed line for feeding the main components may be connected to a general supply for the respective main component, for example a container. In this case, if more than one main component is to be added into each reactor, it is necessary to provide one feed line for each main component.

If mixing of main components is allowed prior to entering the reactor, feed lines for different main components may be connected to a main feed line for all reactors in order to reduce piping complexity.

As an alternative, it is also possible to mix the main components in a feed preparing device before feeding into the tank reactors. If the apparatus comprises such a feed preparing device, the feed preparing device preferably comprises a plurality of vials and a pipetting robot, wherein the pipetting robot is connected to the common feed line. For supplying the main components, the pipetting robot takes the respective component from the vial and the component flows into the main feed line and through the main feed line into the tank reactor. If for analyzing the reaction system different feeds are to be fed into the tank reactors, for example different amounts of reactants or different reactants, it is possible to use the pipetting robot for mixing the feed for one tank reactor by taking the required components from the respective vials in the required amount and feed the components into one tank reactor. After finishing feeding the components into one tank reactor, the feed for another tank reactor is prepared in the same way and fed into the other tank reactor. This is repeated until all tank reactors are filled or until all combinations which are to be analyzed are fed into the tank reactors. This particularly is possible if the apparatus comprises more tank reactors than the number of combinations which is to be analyzed.

If such a feed preparing device is used for mixing the main components before feeding them into the respective tank reactors, it is preferred that the containers for the separate components and the containers for the mixed main components have a size in a range from 100 to 1000 ml.

Particularly if the reaction system comprises components which may react with air or the components may be contaminated, it is preferred to arrange the feed preparing device in a glove-box. The glove-box contains an inert and clean atmosphere so that contamination of the components can be avoided. The common feed line leaves the glove-box so that only the feed preparing device must be arranged in the glove box. The apparatus for analyzing reaction systems can be arranged outside the glove-box. As according to the invention, the pressure in the tank reactors is controlled, it is necessary that the tank reactors are closed, for example by a sealed lid. Therefore, the components in the tank reactors cannot be contaminated by contaminants in the ambient atmosphere or come into contact with air. Further, to avoid remainders of air or contaminants in the tank reactors, it is preferred to flush the tank reactors with an inert fluid, particularly an inert gas, particularly the inert fluid which is contained in the pressure line.

Besides the main components which are fed into the tank reactors via the common feed line, it may be necessary to feed secondary components in small amounts. Such secondary components, for example, are homogeneous catalysts, additives, reaction stoppers, precipitation agents, homogenizers, gelling agents, emulsifiers, nucleators, seeding agents. Due to the small amounts of the secondary components, usually it is not suitable to provide feed lines. Therefore, it is preferred that the apparatus for analyzing reactions comprises a dosing system for feeding secondary components.

The dosing system for example may comprise capillary tubes, vials or microfluidic chips which contain at least one secondary component, the capillary tubes, vials or microfluidic chips being arranged in a holding device in parallel and each capillary tube, vial or microfluidic chip is connected to one tank reactor.

The secondary components which are fed into the tank reactors are filled into the capillary tubes, the vials or the microfluidic chips. The capillary tubes, vials or microfluidic chips then are placed into the holding device. Alternatively, it is also possible to place the capillary tubes, vials or microfluidic chips into the holding device and feed the secondary components into the capillary tubes, the vials or the microfluidic chips while these already are placed in the holding device.

For feeding the secondary components into the vials, the capillary tubes or the microfluidic chips, it is particularly preferred to use a dosing robot. Besides feeding the secondary components into the vials, the capillary tubes or the microfluidic chips by using a dosing robot, it is also possible to feed the secondary components into the capillary tubes, the vials or the microfluidic chips at any place, transport the filled capillary tubes, vials or microfluidic chips to the apparatus for analyzing chemical reactions and insert the filled capillary tubes, vials or microfluidic chips into the holding device.

If more than one secondary component is to be fed into each tank reactor, it is possible to provide all secondary components in one capillary tube, one vial or one microfluidic chip, if the separate components do not react or if a pre-reaction of the secondary components is intended. On the other hand, particularly if the secondary components are not inert to each other, it is preferred to provide each secondary component in one capillary tube, one vial or one microfluidic chip.

For feeding the secondary components from the capillary tubes, the vials or the microfluidic chips into the tank reactors, the capillary tubes, the vials or the microfluidic chips are connected to a pressure line, which contains an inert fluid, particularly an inert gas, for example nitrogen. The inert fluid in the pressure line which is connected to the capillary tubes, the vials or the microfluidic chips has a pressure which is above the pressure in the tank reactors during operation. If further the secondary components are fed into the tank reactor at the start of the reaction and a pressure line is used for controlling the pressure in the tank reactors, it is possible to arrange the capillary tubes, the vials or the microfluidic chips between the pressure line and the tank reactor. In this case, by opening the connection from the pressure line into the tank reactor, the secondary components are transferred from the capillary tubes, the vials or the microfluidic chips into the tank reactor.

If the secondary components are to be fed into the tank reactor after having started the reaction and if a pressure line is used for controlling the pressure in the tank reactors and an additional pressure regulator or flow restrictor is used to set the pressure in the tank reactors such that the pressure in the tank reactors is lower than the pressure in the pressure line, it is also possible to connect the pressure line which is used for controlling the pressure in the tank reactors also to the capillary tubes, the vials or the microfluidic chips. In this case, besides the connection of the capillary tubes, vials or microfluidic chips with the pressure line, an additional connection is provided by which each reactor is connected to the pressure line, wherein this connection only may contain a flow restrictor or a pressure regulator for setting the pressure in the tank reactor.

However, particularly preferably, the capillary tubes, vials or microfluidic chips are connected to a separate pressure line.

If vials are used for providing the secondary components, it is possible to use vials which contain more of the secondary components as used for one reaction. In this case, an additional device is needed for feeding only the required amount of the secondary components into each tank reactor. Such a device for feeding the required amount of the secondary components for example may comprise a valve and a flow restrictor like a capillary tube. Further, the vials are connected to a pressure line which contains an inert fluid, particularly an inert gas like nitrogen. By opening the valve, the secondary component starts to flow from the vial into the tank reactor. Using the flow restrictor allows for accurately dosing the secondary component. As soon as the required amount of secondary component is fed into the tank reactor, the valve is closed. For adding the same amount of secondary components into all tank reactors, it is particularly preferred if the valves are controlled in such a way, that all valves open and close at the same time. The flow restrictors further are calibrated in such a way that by the combination of valve and flow restrictor the same amount of secondary components is fed into each tank reactor. However, in cases where different amounts of secondary components are to be fed into different tank reactors, it is necessary to control the valves separately. Separate control of the valves further allows for feeding the secondary components at different times into the tank reactors. This, for example, may be necessary if the influence of the amount of the secondary component or the influence of the dosing time of the secondary component it to be analyzed.

If it is intended to feed more than one secondary component it is possible to mix the secondary components before feeding and storing the mixture in one capillary tube, vial or microfluidic chip or it is possible to use separate capillary tubes, vials or microfluidic chips for each secondary component so that at least two capillary tubes, vials or microfluidic chips are connected to each tank reactor. Further, if the amount of secondary components to be fed into the tank reactor exceeds the capacity of one capillary tube, vial or microfluidic chip or portions of the secondary component are to be fed into the tank reactor at different times, it is preferred to connect at least two capillary tubes, vials or microfluidic chips to each tank reactor, wherein each capillary tube, vial or microfluidic chip contains the same secondary component or the same mixture of secondary components.

The at least two capillary tubes, vials or microfluidic chips may be connected separately to the tank reactor so that one line leads from each capillary tube, vial or microfluidic chip into a tank reactor. Further, it is possible and preferred to combine the exits of the capillary tubes, vials or microfluidic chips which are connected with one tank reactor into one common feed line so that only the common feed line enters into the tank reactor.

The secondary components can be fed all at once or continuously. By storing the secondary components in a capillary tube or microfluidic chip, a continuous flow is possible without using further devices as the capillary tube or the microfluidic chip directly may serve as flow restrictors for a uniform flow. If the secondary component is stored in vials and a continuous flow of the secondary component is intended, it is preferred to arrange an additional flow restrictor, for example a capillary tube between each vial and the tank reactor. By using this additional flow restrictor, a uniform continuous flow can be achieved and the flow velocity of the secondary component can be set by the diameter of the flow restrictor and the pressure in the pressure line which is connected to the vials.

Independently of being fed all at once or continuously during the reaction time, it is necessary to exactly dose the secondary components. For this purpose, it is preferred that the dosing system for the secondary components comprises supply lines for the secondary components, the supply lines for the secondary components being connected to the tank reactors, wherein each supply line for secondary components comprises two valves and between the valves devices for measuring temperature and pressure. By measuring temperature and pressure before and after adding the secondary component, the amount of the secondary components can be calculated by using equations of state, for example the ideal gas law. Preferably, the supply lines for the secondary components comprise flow restrictors between the valves and particularly preferably, the capillary tubes which contain the secondary component are arranged between the valves.

Besides the dosing of the secondary components by using capillary tubes, vials or microfluidic chips as described above, it is also possible to use a dosing unit which comprises a rotary valve and a dosing loop or a syringe pump. If a syringe pump is used, a vial is connected to one connection of a ⅔-way valve. A second connection of the ⅔-way valve is connected to the syringe pump and a third connection of the ⅔-way valve is connected to a pressure line, which ends in a manifold. For dosing different components, the manifold comprises a plurality of connections, each of which is connected to a pressure line which is connected to a vial for feed. The exit of the manifold is connected to a further ⅔-way valve, a second connection of the further ⅔-way valve is connected to a feed line which enters into a feed distributor and a third connection to an exhaust.

If a rotary valve and a dosing loop are used, the pressure line enters a feed supply which further is connected with the rotary valve having flow paths with a defined volume. One exit of the rotary valve is connected to the dosing loop. A further exit of the rotary valve is connected to an exhaust. One connection adjacent to the connection with the dosing loop of the rotary valve is connected to a supply for a carrier gas. The dosing loop further is connected to a multiport valve. Further connections of the multiport valve are connected to dosing units for further components. The multiport valve comprises one exit which is connected to a feed distributor for distributing the components to the tank reactors.

A further alternative for preparing the secondary components is a feed preparing unit which comprises a pipetting robot as described above for the main components. If such a feed preparing unit is used for preparing the secondary components, the containers for the secondary components and the containers for the mixed secondary components preferably have a size in a range from 5 to 50 ml.

Embodiments of the invention are shown in the accompanying figures and explained in more detail in the following description.

In the figures:

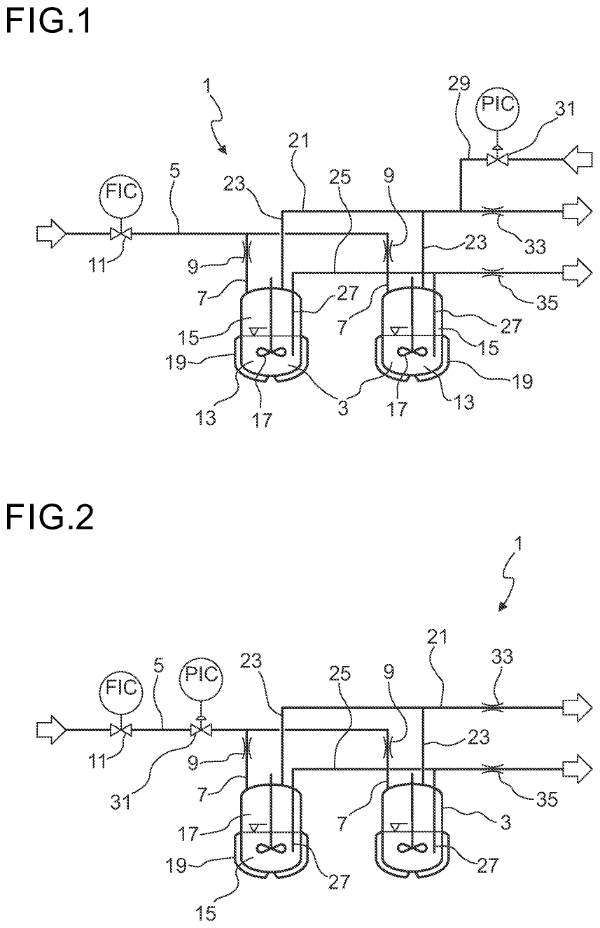

FIG. 1 shows an apparatus for analyzing reaction systems with a pressure line being connected to a common drain line for the gas phase;

FIG. 2 shows an apparatus for analyzing reaction systems with a pressure control in the supply line;

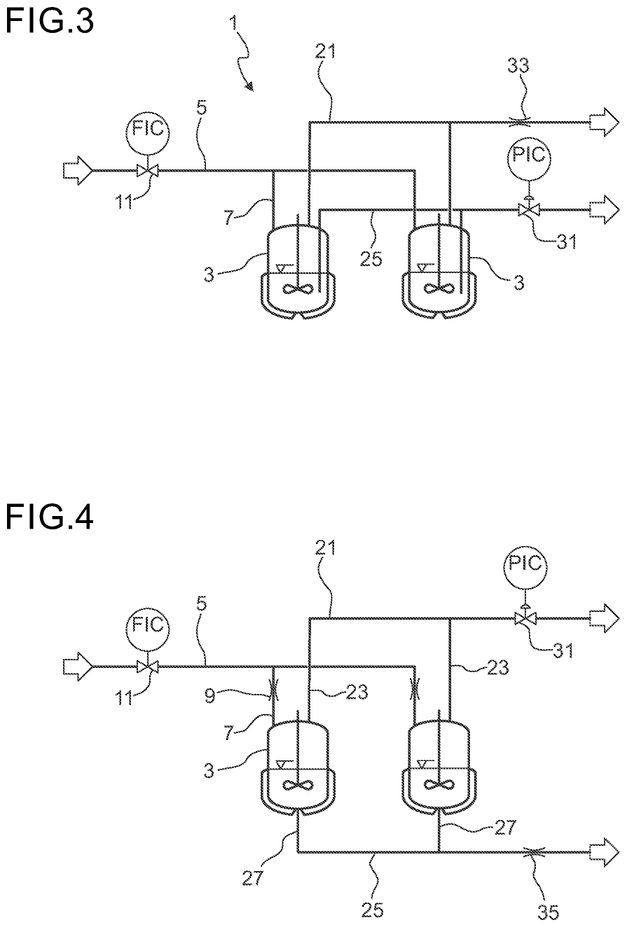

FIG. 3 shows an apparatus for analyzing reaction systems with a pressure control in the common drain line for the liquid phase

FIG. 4 shows an apparatus for analyzing reaction systems with a pressure control in the common drain line for the gas phase;

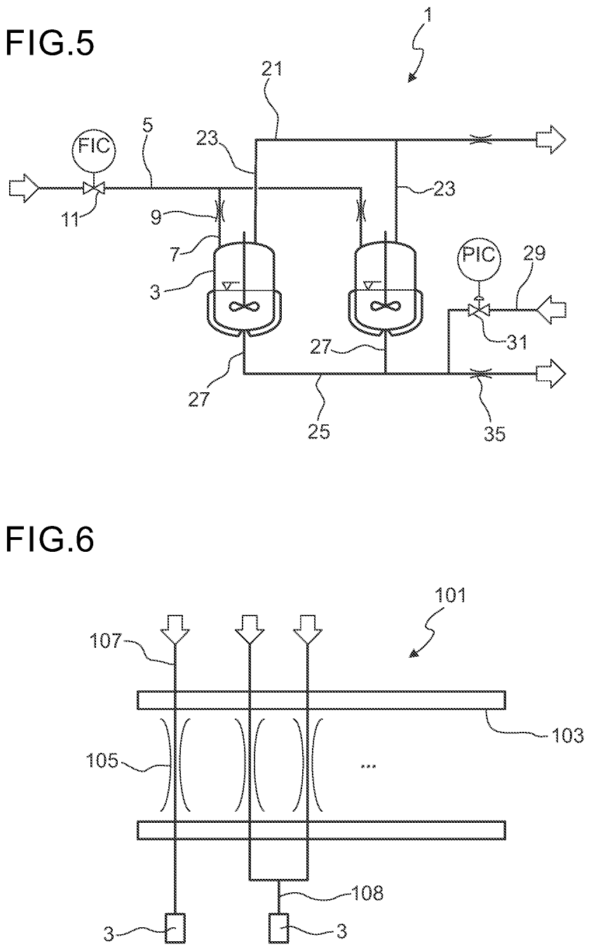

FIG. 5 shows an apparatus for analyzing reaction systems with a pressure line which enters into the common drain line for the liquid phase;

FIG. 6 shows a dosing system for feeding secondary components in a first embodiment;

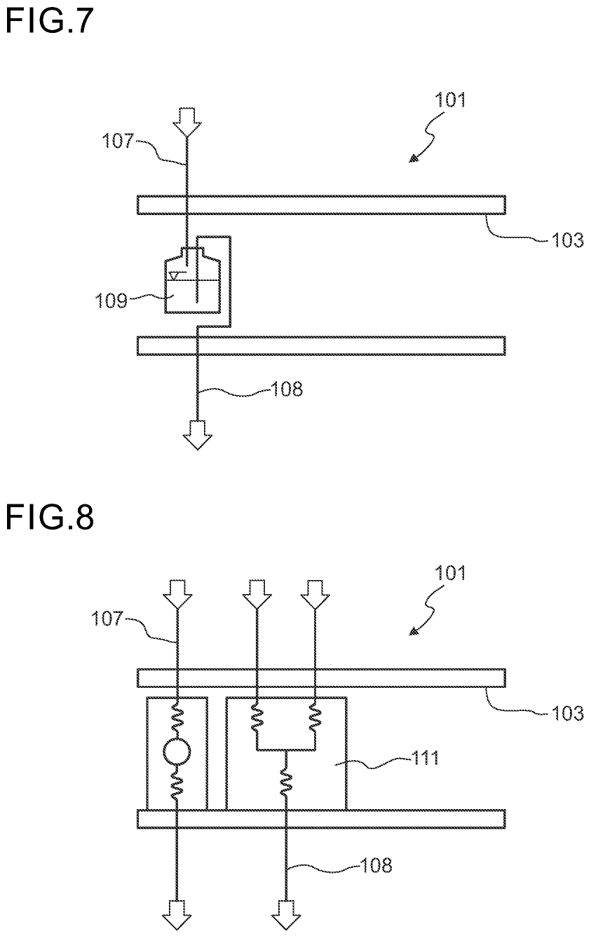

FIG. 7 shows a dosing system for feeding secondary components in a second embodiment;

FIG. 8 shows a dosing system for feeding secondary components in a third embodiment;

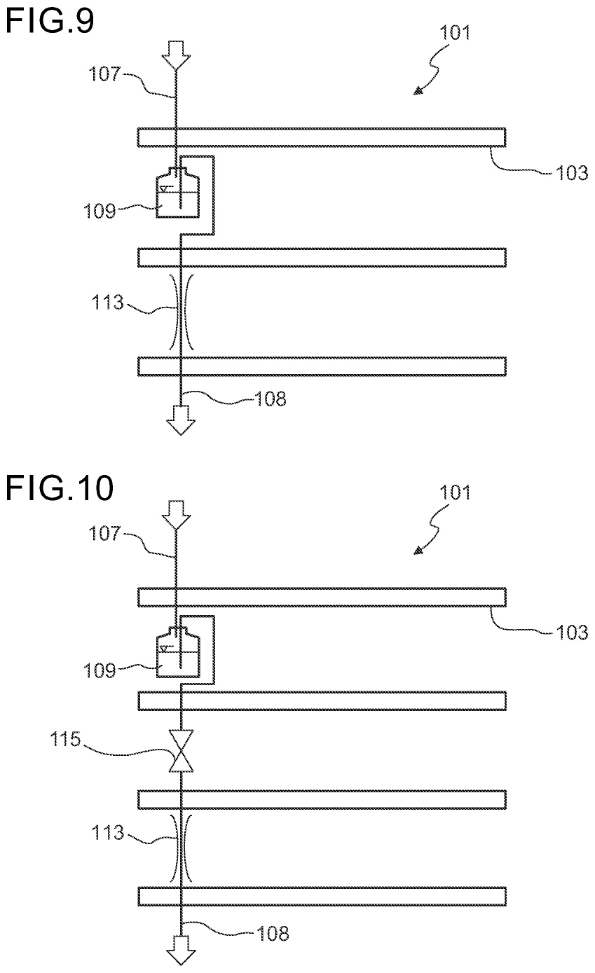

FIG. 9 shows a dosing system for feeding secondary components in a fourth embodiment;

FIG. 10 shows a dosing system for feeding secondary components in a fifth embodiment;

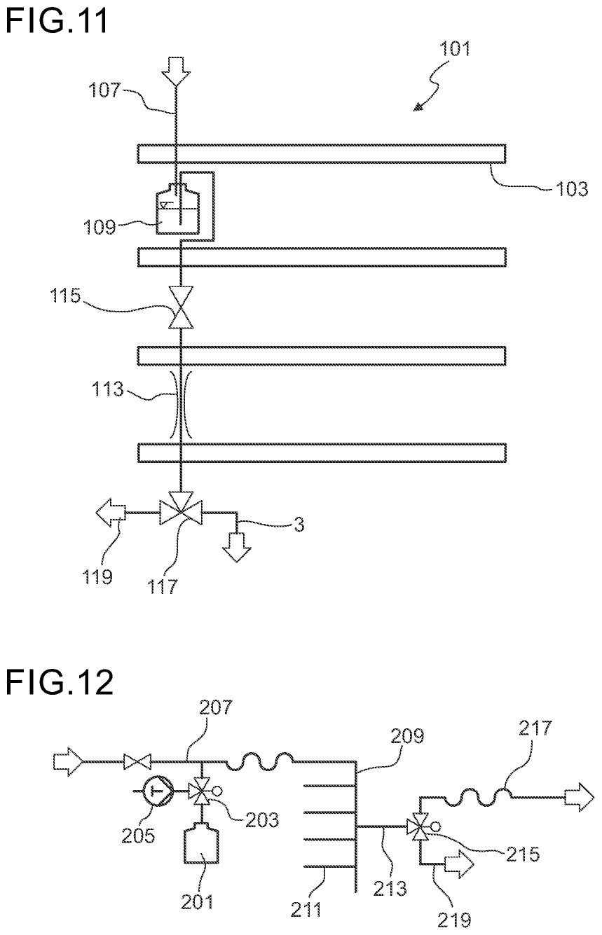

FIG. 11 shows a dosing system for feeding secondary components in a sixth embodiment;

FIG. 12 shows a dosing unit for secondary components with a syringe pump;

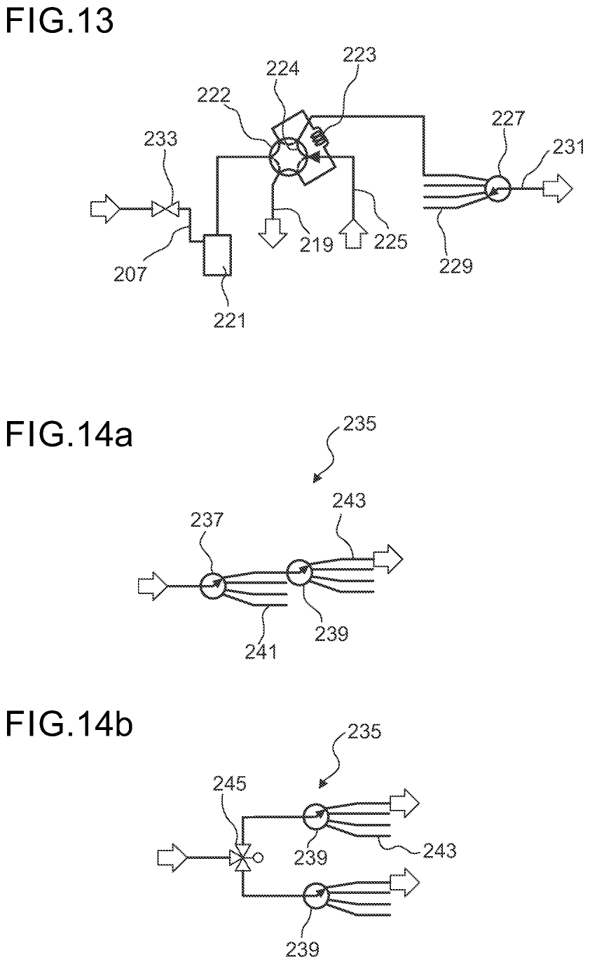

FIG. 13 shows a dosing unit for secondary components with a dosing loop;

FIG. 14 shows two alternatives of a feed distribution for secondary components;

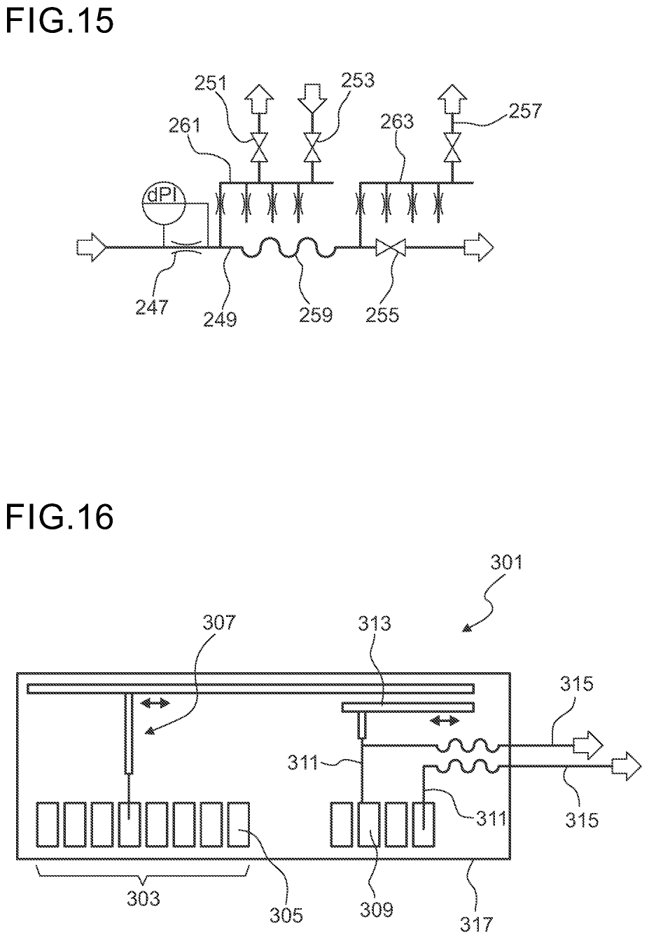

FIG. 15 shows a section of a charger;

FIG. 16 shows a feed preparing device to be used with a syringe pump;

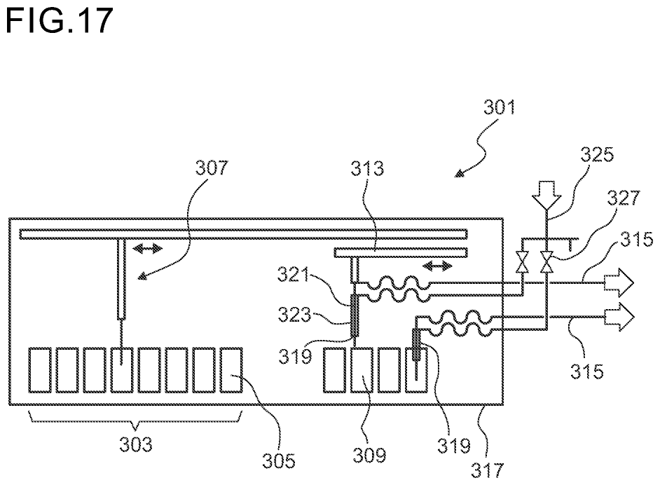

FIG. 17 shows a feed preparing device to be used with a dosing loop.

FIG. 1 shows an apparatus for analyzing reaction systems with a pressure line being connected to a common drain line for the gas phase.

An apparatus 1 for analyzing reaction systems comprises tank reactors 3. The tank reactors 3 preferably are continuous stirred tank reactors. However, depending on the type of reaction system to be analyzed, the tank reactors 3 also can be batch reactors, fed batch reactors or jet loop reactors. For feeding reactants into the tank reactors 3, the tank reactors 3 are connected to a common feed line 5 by supply lines 7. To adjust the flow of the reactants into the tank reactor 3, a flow restrictor 9 is arranged in each supply line 7, the flow restrictor 9 for example being a capillary tube. Further, to set the feed flow, the supply line is equipped with a flow controller 11. By the flow controller the fluid flow can be set in the common feed line 5 and the flow restrictors 9 are used to set the individual feed flow into each of the tank reactors 3.

The tank reactors 3 are used for analyzing reaction systems comprising a liquid phase 13 and a gaseous phase 15. For intimately mixing the liquid phase, the tank reactors 3 preferably are equipped with a mixing device, for example a stirrer 17 as shown here. Further, the tank reactor may be equipped with a heating device or cooling device for setting the temperature of the reaction system during operation. The heating or cooling device for example is a double jacket 19 through which a temperature control medium can flow, as shown here. Besides a double jacket, the heating or cooling device may be designed in the form of pipes which are wound around the tank. If only heating is desired, the heating device may be electrical heating. For cooling, besides using a cooling medium, peltier elements can be used.

For withdrawing gaseous components from the tank reactors 3, each tank reactor 3 is connected to a common drain line 21 for the gas phase by a gas withdrawal line 23 and for withdrawing liquid components, each tank reactor 3 is connected to a common drain line 25 for the liquid phase by a liquid withdrawal line 27. In the embodiment shown here, the liquid withdrawal line 27 entering into the tank reactor 3 is a dip tube.

For setting and controlling the pressure in the tank reactors 3, a pressure line 29 enters into the common drain line 21 for the gas phase. The pressure in the tank reactors 3 is set by a pressure controller 31 in the pressure line 29. By the pressure controller, the pressure downstream the pressure controller and thus in the tank reactors 3 is set. The pressure line 29 contains a pressurized fluid, preferably a pressurized gas, particularly a pressurized inert gas like nitrogen, carbon dioxide or a noble gas, particularly nitrogen. For this purpose, it is particularly preferred to connect the pressure line 29 to a supply for the inert gas, particularly a gas cylinder.

Downstream the point where the pressure line 29 enters into the common drain line 21 for the gas phase, a flow restrictor 33 is arranged in the common drain line 21 for the gas phase. Further, also in the common drain line 25 for the liquid phase, a flow restrictor 35 is arranged. Upstream the flow restrictors 33, 35, the pressure is higher than downstream the flow restrictors 33, 35. Due to the use of the flow restrictors 33, 35 it is possible to set the pressure in the tank reactors 3 by the pressure line 29 which enters into the common drain line 21 for the gas phase even in the event, gas is withdrawn from the gas phase in the tank reactors 3.

FIG. 2 shows an apparatus for analyzing reaction systems with a pressure control in the supply line.

In difference to the embodiment shown in FIG. 1, in FIG. 2 no pressure line enters into the common drain line. For controlling the pressure, here the pressure controller 31 is arranged in the feed line. Thus, the pressure in the tank reactors 3 is set by the pressure of the feed in the feed line. By changing the cross sectional area of the feed line using the pressure controller 31, the pressure in the tank reactors 3 can be set.

Further alternative for controlling the pressure by arranging a pressure control in a drain line are shown in FIGS. 3 and 4.

In the embodiment shown in FIG. 3, the pressure controller 31 is arranged in the drain line 25 for liquid phase. By the flow restrictor 33 in the drain line 21 for the gas phase, the pressure in the gas volume in the reactor 3 is kept at the same pressure level as in the drain line 25 for the liquid phase, which is regulated by the pressure controller 31.

The embodiment shown in FIG. 4 differs from that shown in FIG. 3 in that the pressure controller 31 is arranged in the common drain line 21 for the gas phase instead of the common drain line 25 for the liquid phase and the flow restrictor 35 is arranged in the common drain line 25 for the liquid phase. In this case, the flow restrictor 35 keeps the pressure in the liquid volume of the reactor 3 at the same pressure level as in the common drain line 21 which is regulated by the pressure controller 31. Further, the common drain line 25 for the liquid phase is connected to the tank reactors 3 at the bottom of the tank reactors 3 instead of using a dip tube. By connecting the drain line 25 for the liquid phase to the bottom of the tank reactors, the liquid phase can be withdrawn by gravity. It is not necessary to provide a pressure difference to suck the liquid phase through the dip tube into the common drain line 25 for the liquid phase.

For controlling the liquid by providing the pressure controller 31 in the common drain line 21 for the gas phase or in the common drain line 25 for the liquid phase, a back pressure regulator is used as pressure controller to set the pressure upstream the pressure controller. If the pressure upstream the pressure controller 31 is too high, the pressure controller 31 opens and, thereby, increases the cross sectional area in the respective drain line and the pressure is reduced. A too low pressure upstream the pressure controller 31 results in further closing the pressure controller and decreasing the cross sectional area in the respective drain line by which the pressure upstream the pressure controller increases.

A pressure control in the common drain line 21 for the gas phase or in the common drain line 25 for the liquid phase particularly can be used if the tank reactor 3 is a continuous stirred tank reactor where continuously gas and or liquid is withdrawn from the tank reactor 3.

FIG. 5 shows an apparatus for analyzing reaction systems with a pressure line which enters into the common drain line for the liquid phase.

The embodiment shown in FIG. 5 differs from that shown in FIG. 1 that the pressure line 29 is connected to the common drain line 25 for the liquid phase instead of the common drain line 21 for the gas phase. As the pressure line 29 is connected to the common drain line 25 for the liquid phase, the inert fluid which is contained in the pressure line 29 preferably is an inert liquid. Suitable inert liquids depend on the reaction system to be analyzed in the tank reactors 3 and may be for example solvents which keep the reactants in a liquid state but do not interfere with reaction itself. The type of solvent depends on the solubility of the reactants. Polar reactants are for example well solved for example in water whereas non-polar solvents are solved in organic solvents as for example octene.

This method of pressure control can also be used in purely liquid reactions in which a gas phase does not exist.

In all embodiments shown in the FIGS. 1 to 5, it is possible to either connect the common drain line 25 for the liquid phase with the tank reactor 3 by using a dip tube as shown in FIGS. 1, 2 and 3 or to the bottom of the tank reactor 3 as shown in FIGS. 4 and 5.

The tank reactors 3 used in the apparatus can be produced by any known technique. Particularly preferably, the tank reactors 3 are produced by additive manufacturing.

Further, even though all figures show an apparatus comprising two tank reactors, the apparatus may comprise any number of tank reactors, for example 2 to 96 tank reactors, more preferred 8 to 48 tank reactors and particularly 16 to 24 tank reactors.

FIGS. 6 to 11 show different embodiments of a dosing system for feeding secondary components.

Besides the main components which are fed into the tank reactors 3 via the common feed line 5, also secondary components may be added into the tank reactors 3 in small amounts. Such secondary components for example are catalysts or additives. The dosing system for the secondary components is additionally connected to the tank reactors to directly feed the secondary components from the dosing system into the tank reactors.

FIG. 6 shows a dosing system for feeding secondary components using capillary tubes.

A dosing system 101 for dosing secondary components into the tank reactors 3 comprises a holding device 103, in which capillary tubes 105 are arranged in parallel.

The capillary tubes 105 contain the secondary components and are connected to a pressure line 107. By applying pressure on the capillary tubes 105, for example by using pressurized inert gas like nitrogen, the secondary components flow from the capillary tubes 105 into the tank reactors 3 with which the capillary tubes 105 are connected. Depending on the amount of the secondary component or the number of different secondary components, it is possible to only connect one capillary tube 105 with one reactor or to connect a plurality of capillary tubes 105 with one reactor, which exemplary is shown here for two capillary tubes 105. If more than one capillary tube 105 is connected to one reactor, it is possible that each capillary tube 105 is connected to the respective tank reactor by a separate connecting line or that exit lines of the capillary tubes 105 enter one common supply line 108 for secondary components which then enters into the tank reactor 3.

The embodiments shown in FIGS. 7 and 8 differ from the embodiment shown in FIG. 6 only by the kind of storage for the secondary components. In the embodiment shown in FIG. 7, the capillary tube 105 is replaced by a vial 109 and in FIG. 8, the capillary tubes 105 are replaced by microfluidic chips 111.

Independently of using capillary tubes 105, vials 109 or microfluidic chips 111, the secondary components being stored in the capillary tubes 105, vials 109 or microfluidic chips 111 are transferred into the tank reactors 3 through the supply lines 108 for secondary components by applying pressure using an inert fluid, preferably a pressurized inert gas and particularly pressurized nitrogen.

Further alternatives for a dosing system 101 for dosing secondary components which allow for a continuous dosing of the secondary component are shown in FIGS. 9 to 11.

The embodiment shown in FIG. 9 can be used for feeding the secondary component not all at once but continuously. For this purpose, vials 109 are provided which contain the secondary component. In the supply line 108 downstream the vial 109 a flow restrictor 113 is arranged. The flow restrictor 113 for example is a capillary tube and is used for setting the flow rate of the secondary component fed from the vial 109 into the tank reactors 3.

The embodiment of FIG. 10 differs from that shown in FIG. 9 by additionally providing a same-time-on-stream valve 115 between the vials 109 and the flow restrictor 113. By the same-time-on-stream valve 115 it is possible to feed the secondary components at predefined times or for predefined time periods. The same-time-on-stream valves 115 particularly allow for feeding the secondary components into all tank reactors 3 at the same starting time allowing for a constant reaction time in the reactors when for example a starter agent is injected in all reactors which starts a chemical reaction.

The embodiment shown in FIG. 11 differs from the embodiment of FIG. 10 by additionally providing a pressure drainage. The pressure drainage is realized by providing a 3-way valve 117. The 3-way valve 117 may be set such that the secondary components flow from the vial 109 through the same-time-on-stream valve 115, the flow restrictor 113 and the supply line 107 for secondary components into the tank reactor 3. In a second setting of the 3-way valve 117, the fluid flowing through the supply line 107 for secondary components is drained 119. Further, if only very small amounts of the secondary components are needed, it is also possible to set the 3-way valve such that a part of the fluid flowing through the supply line 107 is fed into the tank reactor 3 and a part is drained 119.

FIGS. 12 and 13 show two alternatives for a dosing unit of small amounts of secondary components.

According to the first alternative, shown in FIG. 12, the dosing unit comprises a vial 201 which contains a secondary component. The vial is connected to one connection of a ⅔-way valve 203. A second connection of the ⅔-way valve 203 is connected to a syringe pump 205 and a third connection of the ⅔-way valve 203 is connected to a pressure line 207. The pressure line ends in a manifold 209. For dosing different components, the manifold 209 comprises a plurality of connections 211, each of which is connected to a pressure line which is connected to a vial for feed. The exit 213 of the manifold is connected to a further ⅔-way valve 215, a second connection of the further ⅔-way valve is connected to a feed line 217 which enters into a feed distributor and a third connection to an exhaust 219.

The dosing unit is used for adding a droplet of secondary component into the tank reactor 3. For this purpose, a portion of the secondary component is drawn from the vial 201 into the syringe pump 205. In a next step the ⅔-way valve 215 is switched in the second position and the portion of the secondary component is transferred from the syringe pump 205 into the pressure line 207 through which an inert gas flows. The portion of the secondary component is transferred in the form of a droplet into the manifold 209 by the inert gas. If more components have to be added into the tank reactor, the further components are transferred in the same way from the other vials to the exit 213 of the manifold 209. The components then are transferred through the ⅔-way valve to a feed distributor by which the components are distributed to the different tank reactors 3. For flushing the dosing unit, inert gas flows through the pressure line, the manifold and the further ⅔-way valve 215 to the exhaust 219.

FIG. 13 shows a dosing unit with a dosing loop.

In this alternative, the pressure line 207 enters a feed supply 221. The feed supply 221 further is connected with a rotary valve 222 having flow paths 224 with a defined volume. One exit of the rotary valve 222 is connected to a dosing loop 223. A further exit of the rotary valve 222 is connected to an exhaust 219. One connection adjacent to the connection with the dosing loop of the rotary valve is connected to a supply for a carrier gas 225. The dosing loop 223 is connected to a multiport valve 227. Further connections 229 of the multiport valve 227 are connected to dosing units for further components. The multiport valve 227 comprises one exit 231 which is connected to a feed distributor for distributing the components to the tank reactors.

If the dosing unit is used for dosing the secondary component, before starting dosing, a valve 233 is opened and pressurized gas flows into the feed supply 221. Thereby the pressure in the feed supply 221 increases and secondary component flows through the connecting line into the rotary valve 222. The rotary valve 222 is switched in such a way that all flow paths 224 in the rotary valve 222 contain secondary component. For dosing the secondary component, the rotary valve 222 then is switched into a position that the flow path 224 which contains the amount of secondary component to be added connects the connection to the dosing loop 223 and the connection to the supply for the carrier gas 225. Due to the gas flow of the carrier gas, the secondary component is transferred from the flow path into the dosing loop 223 and further from the dosing loop 223 to the multiport valve 227.

From the ⅔-way valve 215 if the dosing unit according to FIG. 12 is used or from the multiport valve 227, if the dosing unit according to FIG. 13 is used, the secondary component is transferred by the carrier gas to a feed distributor 235.

Two alternatives of such a feed distributor are shown in FIGS. 14a and 14b.

The feed distributor 235 in the alternative of FIG. 14a comprises a first multiport valve 237 and a second multiport valve 239. Each of the multiport valves 237, 239 comprises one connection by which a fluid enters the respective multiport valve 237, 239 and a plurality of exits.

For distributing the secondary component, each exit 241 of the first multiport valve 237 is connected to a connection of one second multiport valve 239. For the sake of clarity, here only one second multiport valve 239 is shown. Each exit 243 of each second multiport valve 239 is connected to a charger for feeding the secondary component into the tank reactors. This alternative of a feed distributor 235 is particularly suitable if the apparatus for analyzing reaction systems comprises a large number of tank reactors.

The alternative shown in FIG. 14b differs from the alternative of FIG. 14a in that the first multiport valve 237 is replaced by a ⅔-way valve 245. Thus, only two second multiport valves 239 can be connected to the ⅔-way valve 245 and this alternative particularly can be used for an apparatus for analyzing reaction systems having less tank reactors 3.

The feed distributor 235 is followed by a charger as shown in FIG. 15.

The droplet of the secondary component which is carried by the carrier gas through the distributor 235 reaches a phase detector 247. As long as no liquid droplet is detected by the phase detector 247 and gas flows through the feed line 249, a first valve 251 is open and a second valve 253, third valve 255 and fourth valve 257 are closed.

As soon as the phase detector 247 detects the liquid droplet, the first valve 251 is closed and the second valve 253 is opened. For a quick detection, the phase detector preferably comprises a capillary tube and a differential pressure measurement between entry and exit of the capillary tube. As long as gas flows through the phase detector 247, the differential pressure between entry and exit of the capillary tube is low. As soon as liquid enters the capillary tube, the differential pressure rises. This allows for a quick detection of the liquid.

By opening the second valve 253 and closing the first valve 251, the liquid droplet is transferred into a charger 259. After transferring the liquid droplet into the charger 259, the first valve 251 is opened again and the second valve 253 closed.

Each tank reactor 3 of the apparatus for analyzing reaction systems is equipped with a phase detector 247, a feed line 249 and a charger 259. Further, each feed line comprises a third valve 255 through which a liquid droplet can be transferred from the charger 259 into the respective tank reactor 3. Via a first manifold 261, each feed line is connected to the first valve 251 and second valve 253 and via a second manifold 263, each feed line is connected to the fourth valve 257.

The above described process for transferring the liquid droplet of one or more liquids into the charger 259 is repeated for all tank reactors in which the secondary component is to be fed.

After all chargers contain the liquid droplet or a series of liquid droplets of the secondary components, the first and second valves 251, 253 are closed and the third valves 255 are opened, preferably following a request from an automation software which for example requires a dosing from a single or a number of chargers or all chargers in parallel. This process allows for charging the secondary components into all tank reactors 3 at the same time.

Further alternatives for feeding small amounts of a secondary component are shown in FIGS. 16 and 17.

With FIG. 15 a process was described by which primarily a mixture of liquids can create a stack consisting of liquid droplets when a capillary is used as a charger. However, if the capillary is replaced by a volume charger also real mixtures can be composed.

With FIG. 16 now a process is described by which the charger will primarily be filled with only one liquid which is composed of a large number of pre-feeds. This large number creates a large variety of possible composed liquids which are essential for combinatorial research.

In the alternatives shown in FIGS. 16 and 17, an automatized composition of different second components from a large number of pre-feed components can be realized. Further, these embodiments allow for composing the secondary components in an inert atmosphere to avoid contamination of the secondary components.

For dosing different components which may be premixed before being added into the tank reactors, a feed preparing unit 301 comprises a pre-feed supply 303. The pre-feed supply may contain several containers 305, each of which contain one pre-feed component. By a first pipetting robot 307, the components which are needed for the test to be carried out are transferred from the respective container 305 into a vial 309. In the vials 309, different components may thus be mixed. From the vials 309, the feed is taken by a needle 311 of a second pipetting robot 313. The needle 311 is connected to a feed line 315 through which the feed is transported to a dosing unit as shown for example in FIG. 12 or 13.

If a feed preparing unit 301 is used, it is possible to feed the prepared feed into the vial 201 or the feed supply 221 or to replace the vial 201 or the feed supply 221 by the feed preparing unit 301. Further, if it is possible to dose a precise amount of the secondary component with the feed preparing unit 301, it is also possible to connect the feed line 315 directly to a feed distributor as shown in FIG. 14.

For preparing the feed in an inert atmosphere, the feed preparing unit 301 is placed in a glove-box 317. As the feed after having entered the feed line 315 does not come into contact with the atmosphere, it is sufficient to only place the feed preparing unit 301 in the glove-box 317. It is not necessary to enclose the whole apparatus for analyzing reaction systems.

The atmosphere inside the glove-box may be any inert atmosphere, for example an inert gas like nitrogen or a noble gas. Besides a gaseous atmosphere consisting of an inert gas or a mixture of inert gases, it is also possible to evacuate the glove box and operate the feed preparing unit 301 under vacuum.

A second alternative for a secondary feed preparing unit 301 is shown in FIG. 17. The feed preparing unit 301 of FIG. 17 differs from that of FIG. 16 in the type of the second pipetting robot 313. Here, the second pipetting robot 313 is equipped with a double needle 319 having an inner duct 321 and a second duct 323 enclosing the inner duct. The inner duct of the double needle is connected to the feed line 315 and the outer duct of the double needle 319 is connected to a pressure line 325. Each connection from the double needle 319 to the pressure line 325 comprises a valve 327. For transferring feed from the vial 309 into the feed line 315 the double needle 319 is introduced into the respective vial 309, then the valve 327 of this needle is opened and the pressure in the vial 309 increases by inflowing inert gas. By this increased pressure the feed contained in the vial 309 is pressed into the inner duct 321 of the double needle 319 and thus transferred into the feed line 315. As soon as enough feed is transferred into the feed line 315, the valve 327 is closed.

The feed then is transported from the feed line via a dosing unit 201, distribution unit 235 and charger 259 to the tank reactor 3 or, if the feed preparing unit 301 is directly connected to the distribution unit 235, via the distribution unit 235 and the charger 259 to the tank reactor 3 or to the tank reactor 3 directly if the feed preparing unit 301 is directly connected to the tank reactor 3 via a multiport valve with a sample loop similar to FIG. 13.

A feed preparing unit 301 as shown in FIGS. 16 and 17 also can be used for preparing the main components, particularly for mixing main components before adding them into the tank reactors. If such a feed preparing unit 301 is used for preparing the main components, the containers 305 and the vials 309 are much bigger than for a use for preparing the secondary components. Preferably, the containers and the vials have a size in a range from 5 to 50 ml if the feed preparing unit is used for preparing the secondary components and a size in a range from 100 to 1000 ml if the feed preparing unit is used for preparing the main components.

1. An apparatus for analyzing reaction systems with a liquid phase and a gas phase, comprising at least two tank reactors, a common feed line, a common drain line for the liquid phase and a common drain line for the gas phase, each tank reactor being connected to the common feed line by a supply line, to the common drain line for the liquid phase by a liquid withdrawal line and to the common drain line for the gas phase by a gas withdrawal line, wherein the pressure in each tank reactor is controlled by one of:
(a) a pressure control in the common feed line;
(b) a pressure line which is connected to the gas space of each tank reactor;
(c) a pressure control in the common drain line for the gas phase and a flow restrictor in the common drain line for the liquid phase or a pressure control in the common drain line for the liquid phase and a flow restrictor in the common drain line for the gas phase; or
(d) a pressure line which enters into the common drain line for the liquid phase or into the common drain line for the gas phase.

2. The apparatus according to claim 1, wherein the tank reactor is a stirred tank reactor, a continuous stirred tank reactor, a fed-batch reactor, a batch reactor or a jet loop reactor.

3. The apparatus according to claim 1, wherein the pressure line is connected to a supply for an inert gas.

4. The apparatus according to claim 3, wherein the supply for an inert gas is a pressure tank.

5. The apparatus according to claim 1, wherein the liquid withdrawal line enters the tank reactor by a dip pipe.

6. The apparatus according to claim 1, wherein the apparatus comprises a dosing system for feeding secondary components, the dosing system comprising capillary tubes, vials or microfluidic chips which contain at least one secondary component, the capillary tubes, vials or microfluidic chips being arranged in a holding device in parallel and each capillary tube, vial or microfluidic chip is connected to one tank reactor.

7. The apparatus according to claim 6, wherein at least two capillary tubes, vials or microfluidic chips are connected to the same tank reactor.

8. The apparatus according to claim 6 or 7, wherein the dosing system comprises vials and a flow restrictor is arranged between each vial and the tank reactor.

9. The apparatus according to claim 6, wherein the dosing system comprises supply lines for the secondary components, the supply lines for the secondary components being connected to the tank reactors and comprising two valves and between the valves devices for measuring temperature and pressure are arranged.

10. The apparatus according to claim 9, wherein between the valves, a flow restrictor is arranged in the supply line for the secondary components.

11. The apparatus according to claim 1, wherein the apparatus comprises a feed preparing device, the feed preparing device comprising a plurality of vials and a pipetting robot, the pipetting robot being connected to a feed line for secondary components.

12. The apparatus according to claim 11, wherein the feed preparing device is arranged in a glovebox.

13. A process for analyzing reaction systems in an apparatus according to claim 1 by carrying out a reaction in each tank reactor, wherein the pressure in the tank reactors is controlled by one of:
(a) controlling the pressure in the common feed line;
(b) controlling the pressure in a pressure line which is connected to the gas space of each tank reactor;
(c) controlling the pressure in a common drain line for the gas phase or in a common drain line for the liquid phase; or
(d) controlling the pressure in a pressure line which enters into the common drain line for the liquid phase or into the common drain line for the gas phase.

14. The process according to claim 13, wherein for feeding secondary components the pressure in the dosing unit for secondary components is measured before and after adding the secondary component and the amount of the secondary component is calculated by equations of state.
